(19) United States
(12) Patent Application Publication
(10) Pub. No.: US 2017/0346244 A1
(43) Pub. Date: Nov. 30, 2017

(54) Receptacle Relocator

(71) Applicant: Shane Comis, Mission (CA)

(72) Inventor: Shane Comis, Mission (CA)

(21) Appl. No.: 15/168,308

(22) Filed: May 31, 2016

(51) Int. Cl. H01R 25/00; H01R 13/73; H01R 13/72

(52) U.S. Cl. CPC H01R 25/006; H01R 13/72; H01R 13/73

(57) ABSTRACT

The current invention is an electrical relocator. It is designed to make an inaccessible outlet useable. The device plugs into the wired outlet at one end, a new receptacle can be provided in a more convenient location through the use of an extendable bar. A blank cover that has prongs on the backside that fit into the hot, neutral, and grounded openings of the wired socket, which is blocked. Wires running through the hollow bar will carry the power from the blocked outlet to a new outlet attached to the other end of the arm. This new outlet can be secured to the wall in a more convenient location using removable tape or screws.

### METHOD OF USE FIELD OF THE INVENTION

This invention relates to a device that can be used to ‘relocate’ an electric outlet that is blocked by a heavy piece of furniture, rendering it unusable. The device will be used to provide a more useable outlet, which is wired to the one hidden by the piece of furniture. When a nearby outlet is needed, this will make a previously unusable outlet, accessible so it can be used conveniently.

### BACKGROUND OF THE INVENTION

Too often, the closest electrical outlet may be blocked by a piece of heavy furniture. In a living room, where several entertainment devices need access to power, and in offices, cluttered with computers and various accessories, there never seem to be enough outlets. It is very inconvenient when the closest outlet is hidden or covered by a bookcase or couch, making it difficult to reach when it is needed.

There exists a need for a new product to make blocked outlets accessible and easy to use. There is still room for improvement in the art.

### SUMMARY OF THE INVENTION

The present invention relates to an electric receptacle relocator. The unique features and objectives of this invention is to provide the following benefits for consumer: provides for a way to make a previously inaccessible outlet easier to use, eliminates having to have unsightly extension cords lying on the floor near an outlet which is blocked by furniture, and makes it possible to move an outlet up from the floor, so it will be easier to reach when wanting to plug and unplug electric devices.

The current invention, the electric receptacle relocator, is comprised of a case, a hollow for wire to pass through, a power outlet, and an extension. It is designed to make an inaccessible outlet useable. The device plugs into the wired outlet at one end, a new receptacle can be provided in a more convenient location through the use of an extendable bar. A blank cover that has prongs on the backside that fit into the hot, neutral, and grounded openings of the wired socket, which is blocked. Wires running through the hollow bar will carry the power from the blocked outlet to a new outlet attached to the other end of the arm. This new outlet can be secured to the wall in a more convenient location using removable tape or screws.

### BRIEF DESCRIPTION OF THE DRAWINGS

Without restricting the full scope of this invention, the preferred form of this invention is illustrated in the following drawings:

FIG. 1 is a top left solid view of the electric receptacle relocator;

FIG. 2 is a top back left solid view of the electric receptacle relocator;

FIG. 3 is a front view with the extension in use;

FIG. 4 is a top right sectional view of the electric receptacle relocator;

FIG. 5 shows a crosscut side view of the case; and

FIG. 6 shows a schematic of the wiring.

### DETAILED DESCRIPTION

There are a number of significant design features and improvements incorporated within the invention.

All illustrations of the drawings are for the purpose of describing selected versions of the present invention and are not intended to limit the scope of the present invention.

In the present invention, an electric receptacle relocator 1, it is comprised of a case 10, a hollow 20 for wires 30 to pass through, a power outlet 40, and an extension 50. It is designed to make an inaccessible outlet useable. Using this device, which plugs into the wired outlet at one end, a new receptacle can be provided in a more convenient location. An extendable bar is attached to a blank cover that has prongs on the backside that fit into the hot, neutral, and grounded openings of the wired socket, which is blocked. Wires 30 running through the hollow bar 20 will carry the power from the blocked outlet to a new outlet 40 attached to the other end of the arm. This new outlet can be secured to the wall in a more convenient location using removable tape or with screws. The hollow 20 can also be rotated so the new outlet 40 can be attached in any position that is more convenient such as left, right, above or below. The case 10 in the preferred embodiment, which covers the wired outlet, is about ½″ thick so the piece of furniture will still fit against the wall. The new outlet 40 will be about ¾″ thick.

Between the case 10 and the new outlet 40 is the bar 25. The bar 25 is comprised of two components, the extension 50 and the hollow 20. The bar 25 is about ⅜″ thick, with rounded corners, making it easier to adjust its length. It is designed with an extra bend to add strength to the bar 25 so it will not bend when fully extended. Future versions will include a USB port for charging various devices and possibly surge protection.

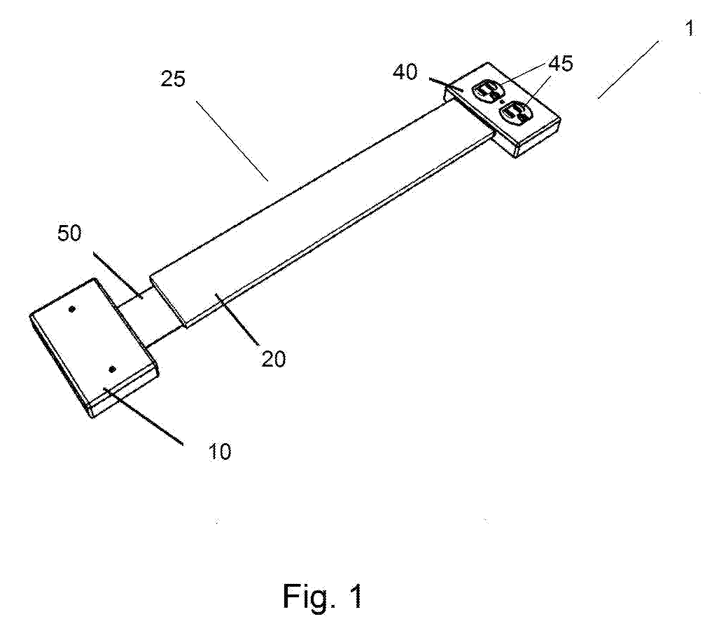

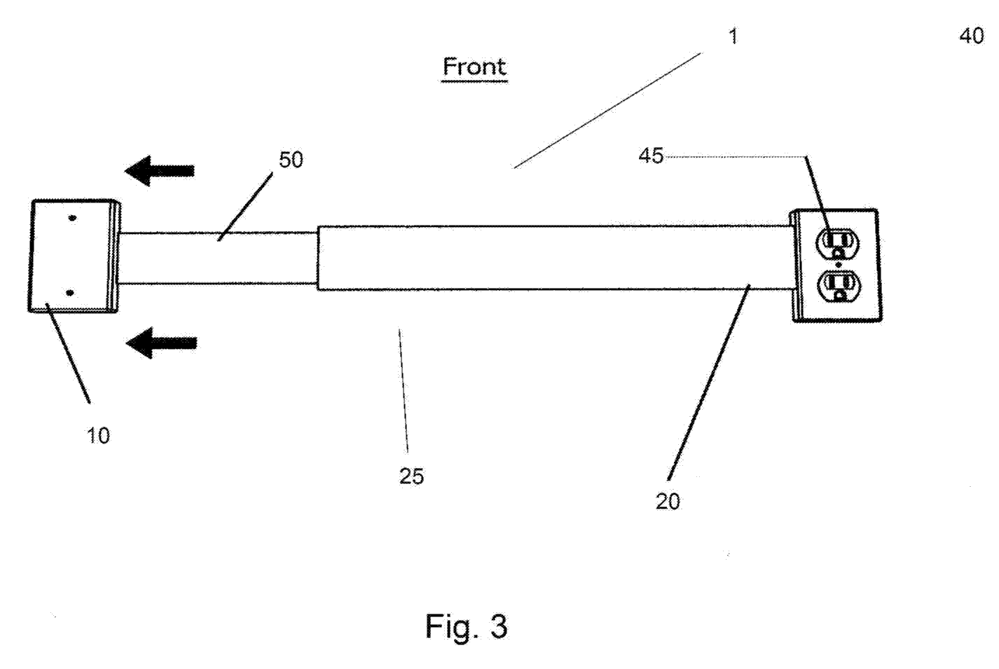

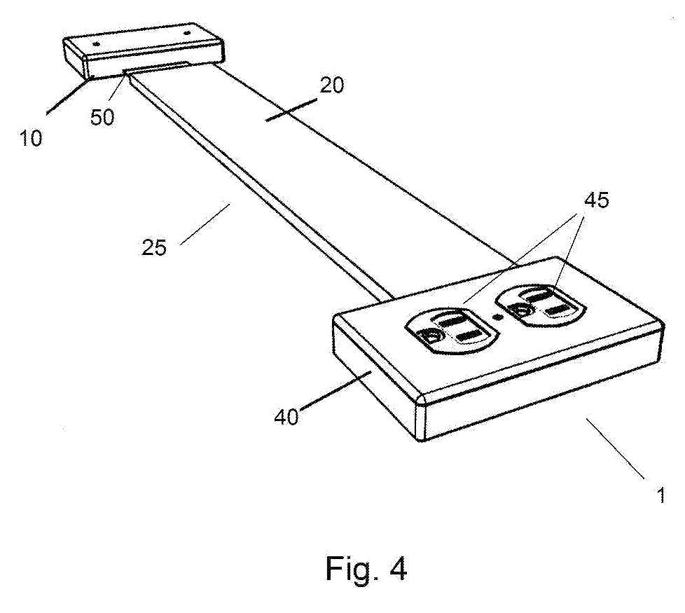

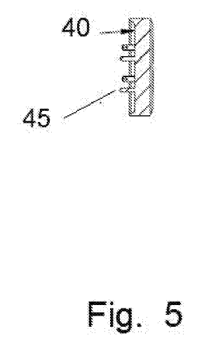

In reference to FIG. 1-FIG. 4, the electric receptacle relocator 1 is an elongated rectangular shaped object that is comprised of a power outlet positioned on both ends. Moreover, the electrical relocate is comprised of a hollow 20 for the wires 30 to pass through which is embedded inside as shown in FIG. 5. The hollow 20 is hollow enough to allow space for wire connector to connect to both ends of the electric receptacle relocator 1 and transport electrical power. The electric receptacle relocator 1 has an extension 50. The extension 50 is an elongated rectangular shaped object and it serves as an extended to extend the electric receptacle relocator 1 and slides inside of the hollow 20. On one end of the electric receptacle relocator 1 is the power outlet 40. It is a rectangular object with curved corners and it is comprised of a female input 45 for power supply outage.

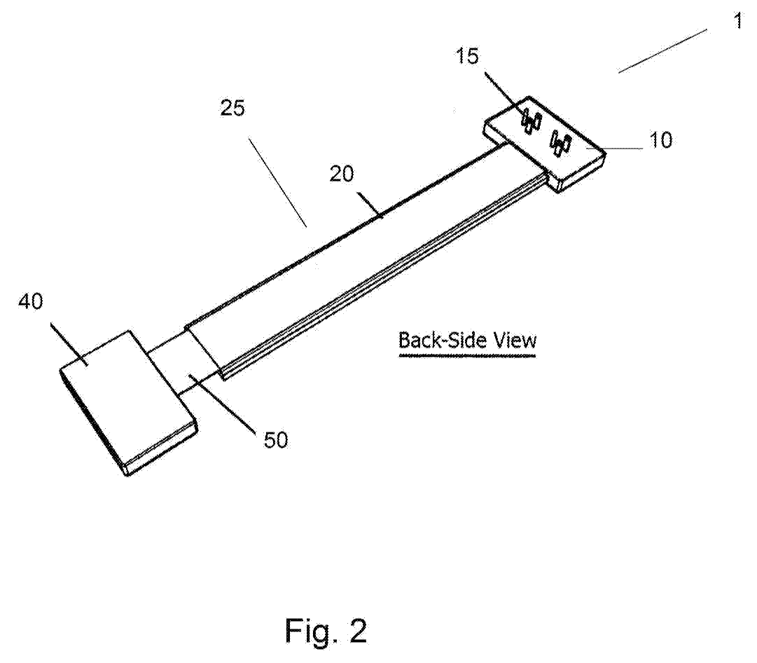

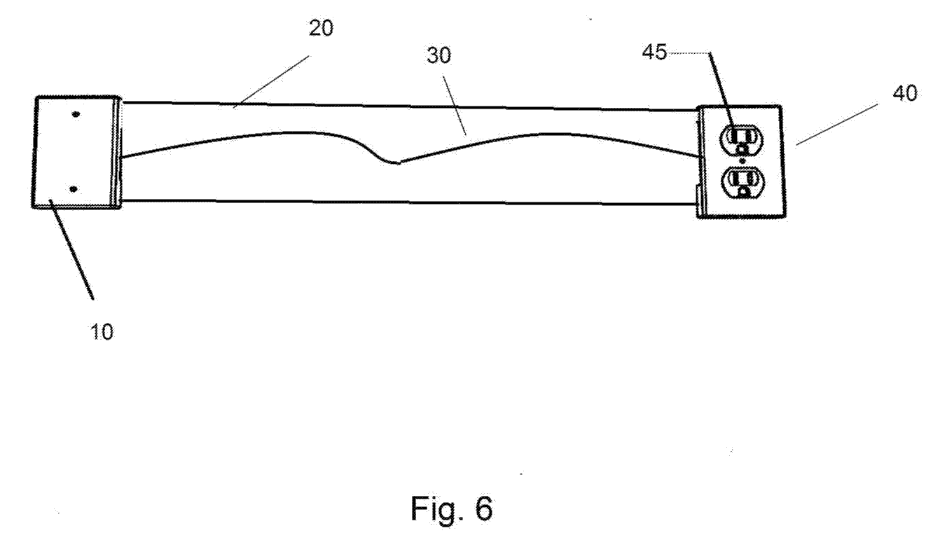

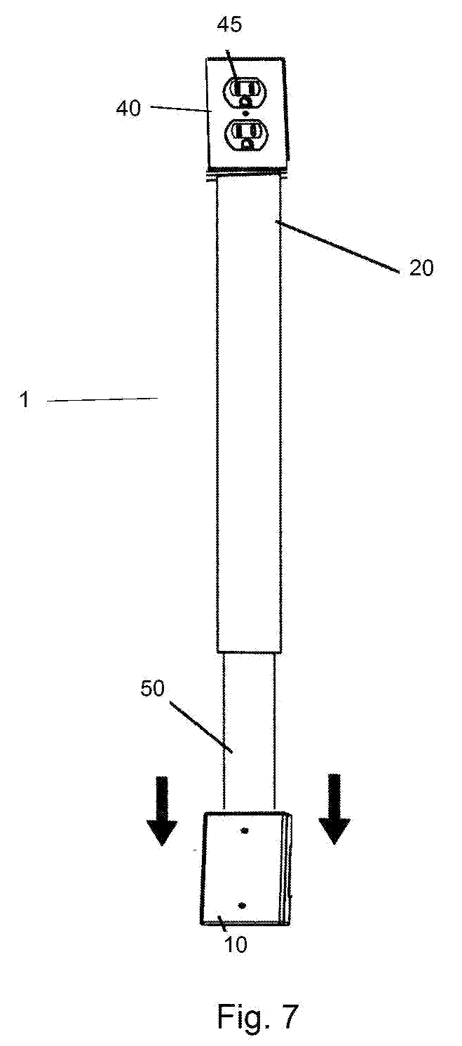

The case 10 is comprised of a subcomponent which is the male outlet plug 15 as shown in FIGS. 2 and 6. It is positioned in the back of the case 10. The male outlet plug 15 is three rounded receptors to connect to a female outlet. On the other end of the electric receptacle relocator is the case. The case 10 is a rectangular shape object with curved corners that is used to cover the power outlet.

The wires 30, as shown in FIG. 6, connect the corresponding male outlet plugs 15 of the case 10 to the corresponding female outlet plugs 45 of the power outlet 40. The wires 30 will be able to handle the proper voltage and amps and will be long enough for when the bar 25 is fully extended but flexible enough for when the bar 25 is fully collapsed.

Although the invention has been explained in relation to its preferred embodiment, it is to be understood that many other possible modifications and variations can be made without departing from the spirit and scope of the invention.

Although the present invention has been described with reference to preferred embodiments, workers skilled in the art will recognize that changes may be made in form and detail without departing from the spirit and scope of the invention.

1. A device comprising:
a case with a front, a back, a top, bottom and right side and left sides with male outlet plugs in the back connected to a bar where the bar is connect to a power outlet with female outlet plugs with wires that run from the male outlet plugs to the corresponding female outlet plugs where said case, is ½″ thick or thinner, having the bar consist of an extension within a hollow where the hollow can also be rotated attaching to either of the left sides, right side, top or bottom and having the extension move within the hollow to change the length of the bar.

2. (canceled)

3. (canceled)

4. The device of claim 1 further comprising having the bar attached to a blank cover that has prongs on the backside.

5. The device of claim 1 further comprising having said wires run through the hollow bar will carry the power from a blocked outlet to a new outlet.

6. The device of claim 1 further comprising having the case secured a wall.

7. (canceled)

8. (canceled)

9. (canceled)

10. The device of claim 1 further comprising where said power outlet has a USB port.

11. The device of claim 1 further comprising where said hollow is elongated rectangular shaped.

12. (canceled)

13. The device of claim 1 further comprising said wires and will be long enough for when the bar is fully extended.

14. The device of claim 1 further comprising said wires are flexible.

15-20. (canceled)
